(19) United States
(12) Patent Application Publication
(10) Pub. No.: US 2010/0288086 A1
(43) Pub. Date: Nov. 18, 2010

(54) Screwdriver Head

(76) Inventor: Ping Wen HUANG, Wurih Township (TW)

Correspondence Address: Wang Law Firm, Inc., 4989 Peachtree Parkway,, Suite 200, Norcross, GA, 30092, US

(21) Appl. No.: 12/233,090

(22) Filed: Sep. 18, 2008

(30) Foreign Application Priority Data
Oct. 5, 2007 (TW) 096137523

(51) Int. Cl. B25B 15/00

(52) U.S. Cl. 81/460

(57) ABSTRACT

An improved screwdriver head structure having a blade portion and a connecting portion, characterized in that: the blade portion is located on one end of the screwdriver head and has two or more engaging surfaces, wherein each of the engaging surfaces is regularly disposed with a plurality of protruding cones at equal distance, the tip of each of the protruding cones has a touching point, and the touching points of the protruding cones are on the same plane; the connecting portion is located on the other end of the screwdriver head for the connection with a screwdriver handle; and when a user uses the blade portion to fasten a screw, the touching points of the protruding cones on the blade portion fully engage with the screw, thereby providing larger friction and even force distribution.

### BACKGROUND OF THE INVENTION

1. Field of Invention

The invention relates to the hand tool screwdriver and, in particular, to an improved screwdriver head.

2. Related Art

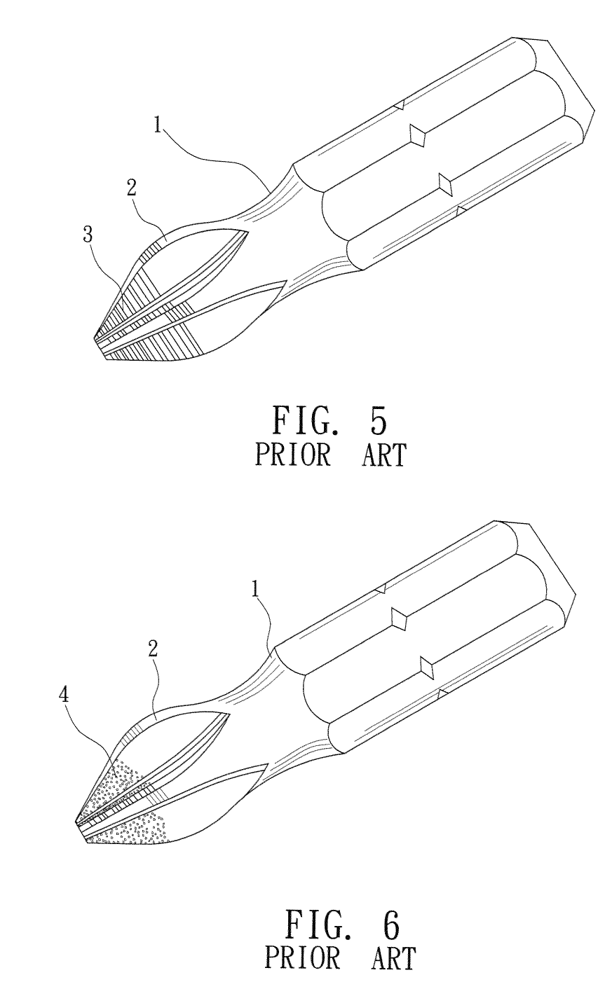

In a conventional screwdriver, the blade portion of its head always has a smooth surface. Therefore, when fastening or loosening a screw, it may slip because of insufficient friction between the screwdriver head and the screw. This affects its operation. To solve the problem, as shown in FIG. 5, an improved screwdriver head has several horizontal grooves 3 on the blade portion 2 of the screwdriver head 1. This can increase the friction between the screwdriver head 1 and the screw. However, the anti-skid effect of such a design is still limited in practice.

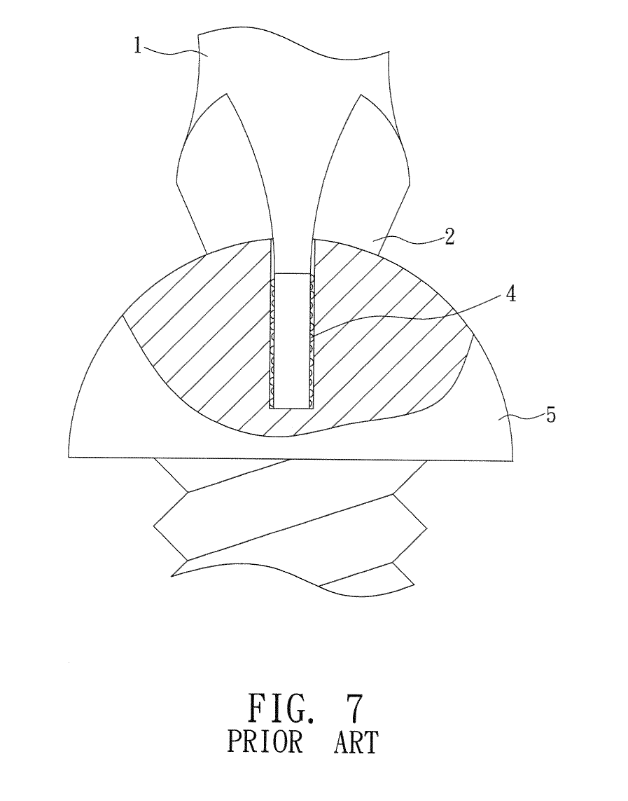

As shown in FIG. 6, some manufacturers make irregularly distributed anti-skid particles 4 on the blade portion 2 of the screwdriver head 1, thereby increasing the friction between the screwdriver head 1 and the screw. Such anti-skid particles 4 are formed by spraying diamond powders directly on the blade portion 2 of the screwdriver head 1 or formed integrally. In practice, the force may be distributed non-uniformly. As shown in FIG. 7, the anti-skid particles 4 are irregularly distributed on the blade portion 2 of the screwdriver head 1. They have different sizes. Therefore, the anti-skid particles 4 cannot have perfect contact with the screw 5. Larger anti-skid particles 4 may also fall off because they are under larger stress.

### SUMMARY OF THE INVENTION

An objective of the invention is to provide an improved screwdriver head structure. The blade portion of the screwdriver head has regularly disposed protruding cones. Therefore, when the screwdriver head is in contact with a screw, the friction can be increased and the force is evenly distributed.

To achieve the above-mentioned objective, the improved screwdriver head structure according to the invention includes: a blade portion and a connecting portion. The blade portion is located at one end of the screwdriver head and has two or more engaging surfaces. Each of the engaging surfaces has a plurality of protruding cones regularly distributed at equal distance thereon. The tip of each protruding cone has a touching point, and all the touching points are on the same plane. The connecting portion is located on the other end of the screwdriver head for the connection with a screwdriver handle.

When a user uses the blade portion to fasten a screw, the touching points of the protruding cones thereon can have full contact with the screw, increasing the friction and evenly distributing the force as well.

BRIEF DESCRIPTION OF THE DRAWINGS

The invention will become more fully understood from the detailed description given herein below illustration only, and thus is not limitative of the present invention, and wherein:

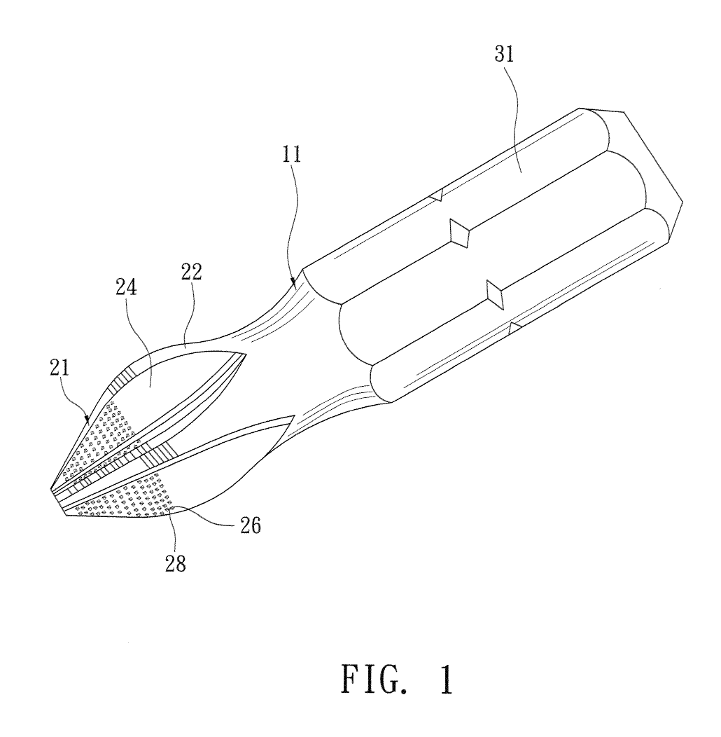

FIG. 1 is a three-dimensional view of the invention;

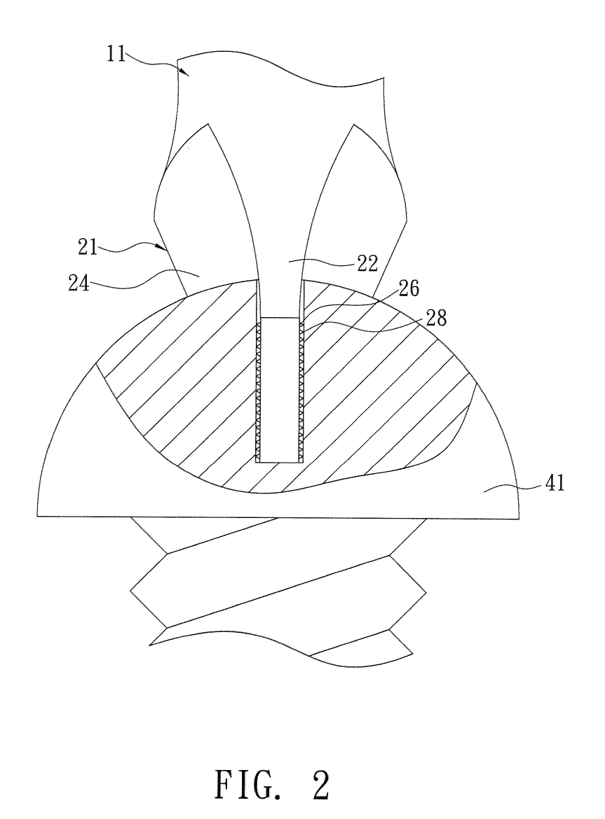

FIG. 2 is a schematic view showing how the invention is used;

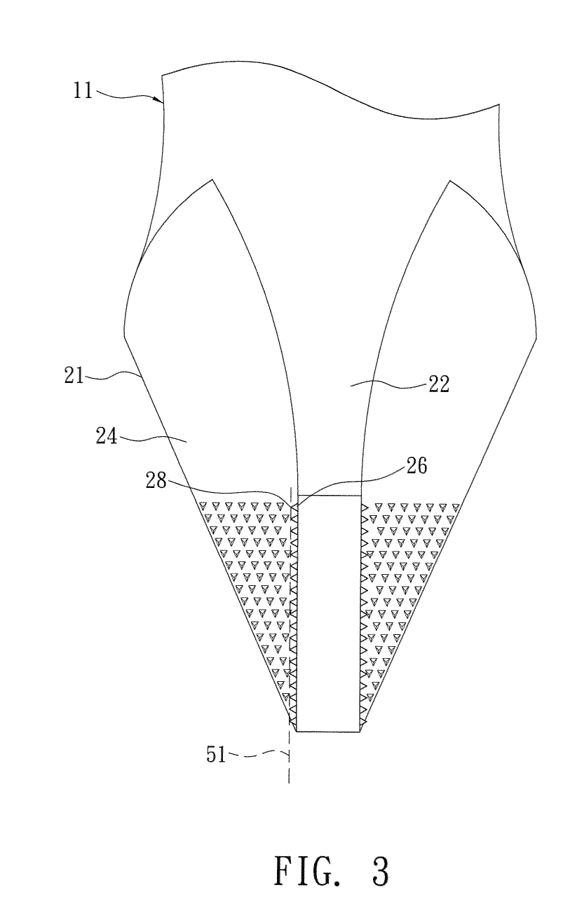

FIG. 3 is a locally exploded schematic view of the invention;

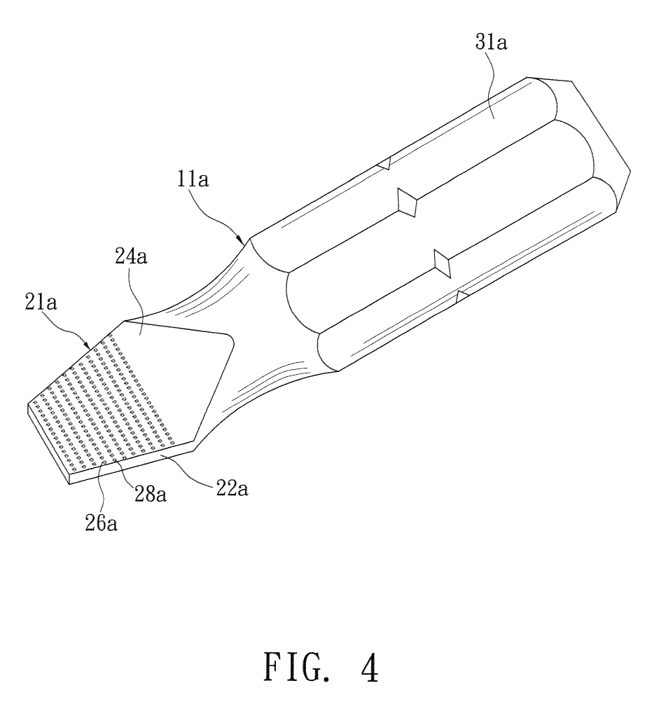

FIG. 4 is a three-dimensional view of a second embodiment of the invention;

FIG. 5 is a three-dimensional view of one conventional screwdriver head;

FIG. 6 is a three-dimensional view of another conventional screwdriver head; and

FIG. 7 is a schematic view showing how the conventional screwdriver head is used.

### DETAILED DESCRIPTION OF THE INVENTION

The present invention will be apparent from the following detailed description, which proceeds with reference to the accompanying drawings, wherein the same references relate to the same elements.

Please refer to FIG. 1. An improved structure of the screwdriver head 11 according to the invention consists of a blade portion 21 and a connecting portion 31. The features of the invention are as follows.

The blade portion 21 is located on one end of the screwdriver head 11. Here the screwdriver is a Phillips screwdriver. The blade portion 21 has four engaging pieces 22 and thus eight engaging surfaces 24. Each of the engaging surfaces 24 is distributed with several protruding cones 26 of the same shape and size. The protruding cones 26 are disposed regularly at equal distance on the engaging surfaces 24. The tip of each of the protruding cones 26 has a touching point 28. The touching points 28 of the protruding cones 26 are on the same plane 51.

The connecting portion 31 is located on the other end of the screwdriver head 11. The connecting portion 31 is in a hexagonal cylinder shape for the connection with a screwdriver handle or a sleeve (not shown).

Please refer to FIGS. 2 and 3. Suppose a user uses the blade portion 21 to engage a screw 41 for fastening or loosening. Since the protruding cones 26 on the blade portion 21 are disposed regularly at equal distance, they all have the same size and shape, and the touching points 28 of the protruding cones 26 are on the same plane 51, the touching points 28 of the protruding cones 26 can fully engage with the screw 41. Not only does the friction increases, the operating force is also evenly distributed. Therefore, the disclosed screwdriver head 11 becomes more convenient and efficient.

Please refer to FIG. 4 for a second embodiment of the invention. The screwdriver 11a is a flat screwdriver. The blade portion 21a is one engaging piece 22a with two engaging surfaces 24a. The two engaging surfaces 24a are also disposed with protruding cones 26s of the same size and shape. These protruding cones 26a are also disposed evenly at equal distance on the engaging surfaces 24a. The touching points 28a on the tips of the protruding cones 26a are also on the same plane 51a. With such a design, the flat screwdriver head 11a has a larger friction with a screw. The operating force can be evenly distributed as well.

However, it should be mentioned that each of the protruding cones 26 can be a triangular cone, pyramid cone, or some multi-angle cone.

According to the above-mentioned structure, the invention has the following advantages:

1. The protruding cones help increase the friction between the invention and the screw, improving the anti-skid effect.

2. The protruding cones are disposed regularly at equal distance on the engaging surfaces. When the screwdriver engages with a screw, the touching points on the protruding cones can fully engage with the screw. The operating force can thus be evenly distributed, enhancing the convenience and efficiency of the screwdriver head.

3. When in use, each of the protruding cones receives the same force. Therefore, they are less likely to break. The screwdriver thus has a longer lifetime.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An improved screwdriver head structure, comprising:
a blade portion, which is located on one end of the screwdriver head and has two or more engaging surfaces, each of the engaging surfaces being regularly disposed with a plurality of protruding cones at equal distance, the tip of each of the protruding cones having a touching point, and the touching points of the protruding cones being on the same plane; and
a connecting portion, which is located on the other end of the screwdriver head for the connection with a screwdriver handle;
wherein when a user uses the blade portion to fasten a screw, the touching points of the protruding cones on the blade portion fully engage with the screw, thereby providing larger friction and even force distribution.

2. The improved screwdriver head structure of claim 1, wherein the screwdriver head is a Phillips screwdriver head and the blade portion has four engaging pieces and eight engaging surfaces.

3. The improved screwdriver head structure of claim 1, wherein the screwdriver head is a flat screwdriver head and the blade portion has one engaging piece and two engaging surfaces.

4. The improved screwdriver head structure of claim 1, wherein the connecting portion is in the shape of a hexagonal cylinder.

5. The improved screwdriver head structure of claim 1, wherein each of the protruding cones is in the shape of a multi-angle cone.
